(19) United States
(12) Patent Application Publication
(10) Pub. No.: US 2015/0251281 A1
(43) Pub. Date: Sep. 10, 2015

(54) METHOD FOR RESURFACING AT LEAST ONE ARM OF AN INTERMEDIATE CASING OF A TURBOMACHINE

(71) Applicant: SNECMA, Paris (FR)

(72) Inventors: Damien Hebuterne, Breux-Jouy (FR); Jean-Francois Castagne, Bourg La Reine (FR); Jerome Guinois, Corbeil Essonnes (FR)

(73) Assignee: SNECMA, Paris (FR)

(21) Appl. No.: 14/440,427

(22) PCT Filed: Oct. 22, 2013
(86) PCT No.: PCT/FR2013/052528

§ 371 Date: May 4, 2015

(30) Foreign Application Priority Data
Nov. 5, 2012 (FR) 1260489

(51) Int. Cl. B23P 6/00; F01D 25/24; B23K 9/173; B23K 9/09; B23K 9/04

(52) U.S. Cl. CPC B23P 6/007; B23K 9/093; B23K 9/042; B23K 9/173; F01D 25/24; F05D 2230/80; F05D 2230/90; F05D 2220/30

(57) ABSTRACT

A method for resurfacing at least one arm of an intermediate casing of a turbomachine, such as a turbojet engine or a turboprop engine of an aircraft, including striking off at least one end of the arm to be resurfaced, resurfacing the struck-off end of the arm by adding filler metal using a short-circuit transfer MIG welding method, also called CMT (Cold Metal Transfer) method, machining the resurfaced portion of the arm so as to provide it with the required geometry.

The present invention relates to a method for resurfacing at least one arm of an intermediate casing of a turbomachine such as a turbojet engine or a turboprop engine in a plane.

A turbomachine conventionally comprises, from upstream to downstream, a fan, a low-pressure compressor, an intermediate casing, a high-pressure compressor, a combustion chamber, a high-pressure turbine and a low-pressure turbine. Air entering the turbomachine is divided into a main stream flowing inside the low- and high-pressure compressors, and a by-pass flow which bypasses the compressor, the combustion chamber and the turbine.

The intermediate casing comprises an outer shroud and an inner hub defining a portion of the jet wherein the by-pass stream flows. The shroud and the hub are connected together by radial structural arms which are circumferentially spaced from each other at regular intervals. Such arms have a high mechanical strength making it possible, on the one hand, to transmit the forces from the shroud to the hub and, on the other hand, to withstand any projectiles that might impact these.

In addition, the arms each have a shape so contoured as to perform a function of outlet guide vane or OGV so as to straighten the by-pass air flow in order to limit the turning thereof.

During the production of the intermediate casing, defects may be generated on the arm during a machining, in particular when the cutting tool used for machining is damaged.

The defects due to a machining usually appear at the radially outer ends of the arms, particularly at shoes provided at these ends.

Moreover, upon welding the arms onto the casing material shrinkage phenomena may cause dimensional nonconformities.

To remedy such defects, some shoes can be struck-off and then resurfaced by depositing material using a TIG (Tungsten Inert Gas) welding method. The resurfaced portion is then machined so as to provide it with the required geometry while complying with the dimensional specifications of the arm.

Resurfacing is manually executed by an operator and lasts about 20 hours. It is generally necessary to provide 9-10 successive resurfacing layers to achieve the desired material thickness. The TIG method is also relatively energetic and the global heating of the shoe frequently causes crippling deformations.

The invention particularly aims at providing a simple, efficient and economical solution to this problem.

For this purpose, it provides a method for resurfacing at least one arm of the intermediate casing of a turbomachine such as a turbojet engine or a turboprop engine in a plane, characterized in that it comprises the steps consisting in:
striking off at least one end of the arm to be resurfaced,
resurfacing the struck-off end of the arm by adding filler metal using a short-circuit transfer MIG welding method, also called CMT (Cold Metal Transfer) method, wherein a consumable electrode is used as a filler metal,
machining the resurfaced portion of the arm so as to provide it with the required geometry,

and in that, upon resurfacing using the CMT method, a synergistic law is used, which comprises an ignition cycle during which the intensity I of a current flowing through the electrode varies from a minimum value of 50 to 70 A to a maximum value of 130 to 140 A, followed by several pulse cycles during which the intensity I varies from a minimum value of 70 to 100 A to a maximum value of 280 to 320 A.

Said arm is advantageously made of a titanium alloy, and the starting cycle comprises the following successive phases:
a first phase of removing an electrode and generating a short-circuit, during which the electrode is moved away from the struck-off end to be resurfaced at a maximum speed Vd of −1 to −3 m/min, with the negative value indicating a distance from the electrode and the struck-off end to be resurfaced, with the intensity I being maintained at a reduced threshold, of 50 to 70 A and the voltage U being substantially zero,
a phase of pulse and of generating an arc during which the movement of removing the electrode ends and then the electrode is placed closer to the struck-off end to be resurfaced until the speed Vd reaches a maximum threshold of 24 to 26 m/min, and during which the intensity I increases up to a threshold of 130 to 140 A, with the effect of generating an electric arc,
a so-called combustion phase during which the speed Vd is maintained at the threshold of 24 to 26 m/min, with the intensity I being reduced to a threshold of 90 to 110 A, sufficient to maintain the existence of an electric arc, and during which, upon completion of such phase, the electrode touches the struck-off end to be resurfaced again so as to generate a short-circuit and to extinguish the arc, if the electric arc was maintained during the combustion phase,
a second phase of removing the electrode and of generating a short circuit during which the electrode is moved away from the struck-off end to be resurfaced at a maximum speed Vd of −1 to −3 m/s, with the intensity I being maintained at a reduced threshold, of 50 to 70 A and the voltage U being substantially zero,

and in that during the pulse cycles, the speed Vd is adjusted to a stable value of 2 to 7 m/min so that the electrode is gradually consumed and the intensity I cyclically varies between a minimum value of 70 to 100 A and a maximum value of 280 to 320 A.

Furthermore, according to another characteristic of the invention:
the duration of the first phase of removing ranges from 0.5 to 4 ms, and/or
the duration of the pulse phase and of generating an arc ranges from 1 to 3 ms, and/or
the duration of the combustion phase ranges from 0.5 to 4 ms, and/or
the duration of a pulse cycle ranges from 2 to 2.5 ms.

During the starting cycle, the electrode is advantageously moved relative to the struck-off end to be resurfaced at a constant speed between 20 cm/min and 50 cm/min.

The number of pulse cycles preferably ranges from 80 to 120.

According to another characteristic of the invention, during the pulse cycles, the feed speed of the electrode relative to the end struck-off to be resurfaced is maintained substantially constant and ranges from 10 to 120 cm/min.

Upon completion of the resurfacing of the struck-off end of the arm, a local thermal treatment of said arm can also be carried out.

Resurfacing, using a method of the CMT (Cold Metal Transfer) type, makes it possible to significantly reduce the heating in the arm and thus to limit the reduction in the mechanical properties of the material and to prevent deformations of the arm.

Such resurfacing method particularly makes it possible to reduce the heat-affected zone or HAZ, which is subjected to metallurgical changes in the base metal that can induce fragility, a reduction in the mechanical strength or a lack of ductility.

Such a method also makes it possible to reduce the number of successive resurfacing layers, so that resurfacing time can be significantly reduced. Eventually, the implementation of the CMT method can be automated, using a numerically controlled machine.

Besides, such a method is ideally suited to titanium alloys, in particular alloys of the TA6V type, and to the geometry of the shoe to be resurfaced and of the arm the free end of which supports said shoe, since it uses a suitable law developed therefor, within the scope of the invention.

The CMT method is specifically known from the document U.S. Pat. No. 8,124,913.

Advantageously, during the step of resurfacing of the struck-off end of the arm, the CMT method parameters are controlled so as to limit the heating of the resurfaced zone. For this purpose, the end of the arm may be equipped with at least one temperature sensor such as a thermocouple.

It should be reminded here that a sensor of the thermocouple type comprises at least a junction of two metals having a different nature, subjected to different temperatures. In the case of the invention, one of the metals is brought to the temperature of the end zone at which the thermocouple is mounted, with the other metal being maintained at a reference temperature. By Seebeck effect, the thermocouple generates a potential difference which depends on the temperature difference between the two metals. Such a temperature sensor has the advantage of being used in a relatively large temperature range, and in particular for high temperatures.

The thus measured temperature values are used to control the parameters of the CMT method, such as in particular the intensity of the current flowing through the electrode or the feed speed of the electrode relative to the surface to be resurfaced, so to avoid a significant heating of the resurfaced zone and the damaging of the arm of the intermediate casing.

According to one embodiment of the invention, during the step of resurfacing, a bead of material is first provided at least along the edges of the struck-off surface of the end of the arm, and material is then applied onto the remainder of the struck-off surface.

This characteristic thus enables a better control of the dimensions of the resurfaced zone.

During the step of resurfacing, the arm is preferably mounted in an enclosure containing an inert gas.

The chamber may comprise a removable plate comprising an opening for the passage of a welding tool, positioned opposite the end of the arm to be resurfaced.

In addition, the titanium alloy used for the arm can be TA6V, with the filler metal used in the CMT welding being TA6V.

The method is preferably automatically executed on a numerically controlled machine.

The invention will be better understood and other details, characteristics and advantages of the invention will appear upon reading the following description given by way of a non-restrictive example while referring to the appended drawings, wherein:

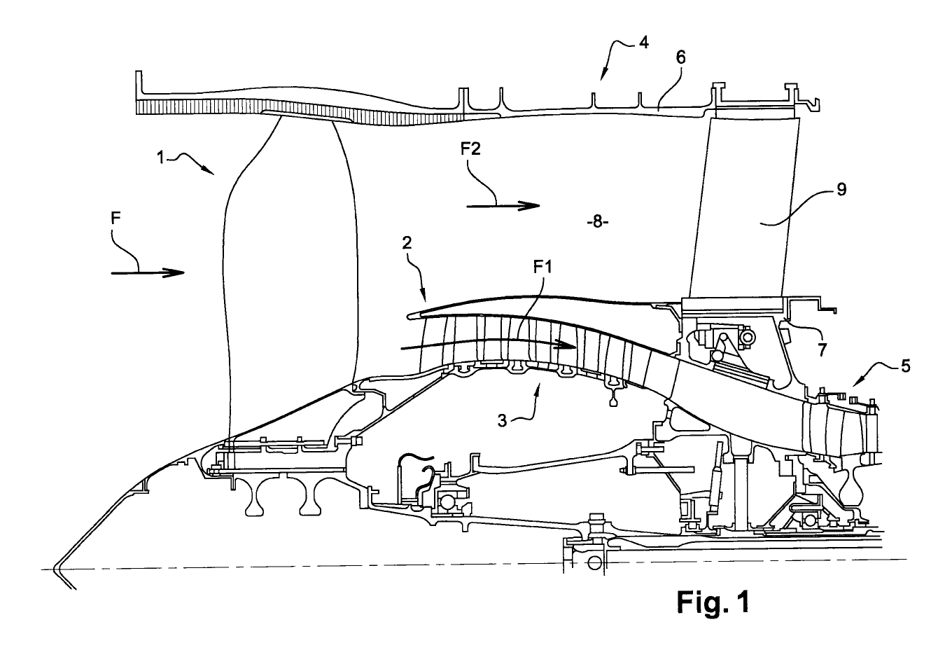

FIG. 1 is a schematic half-sectional view of an upstream part of a turbojet engine of the prior art,

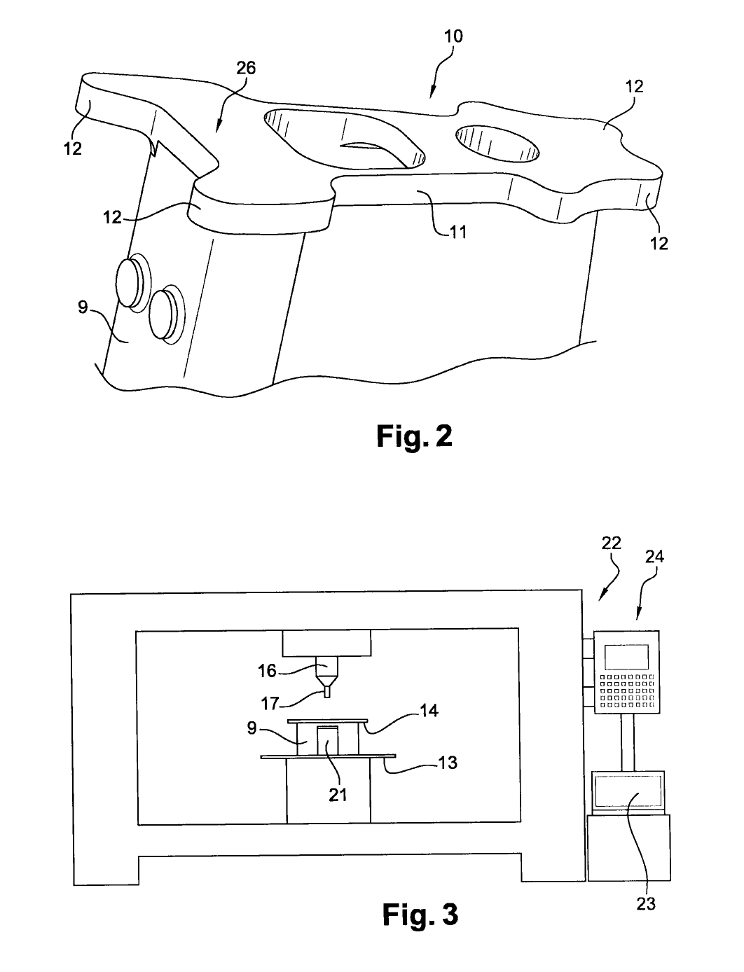

FIG. 2 is a perspective view of an end shoe of the arm of an intermediate casing, obtained after striking-off the shoe and prior to the resurfacing thereof using the method according to the invention,

FIG. 3 is a view illustrating the mounting of the arm in a numerically controlled machine for the step of resurfacing the end of the arm,

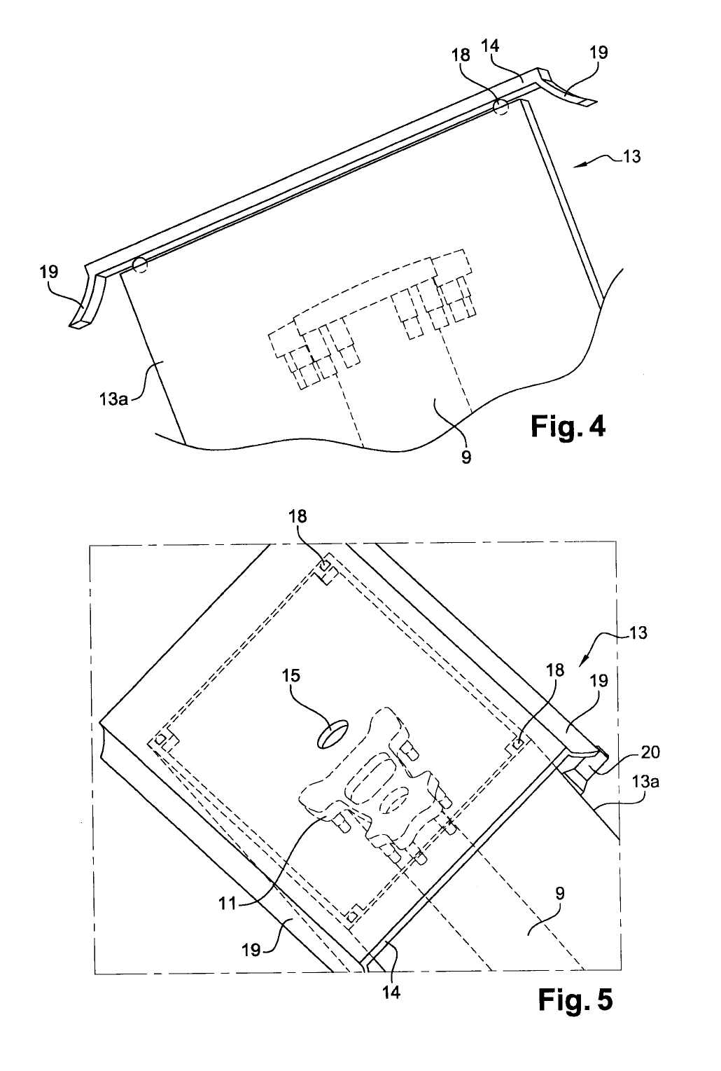

FIGS. 4 and 5 are views illustrating the mounting of the arm in an enclosure containing an inert gas,

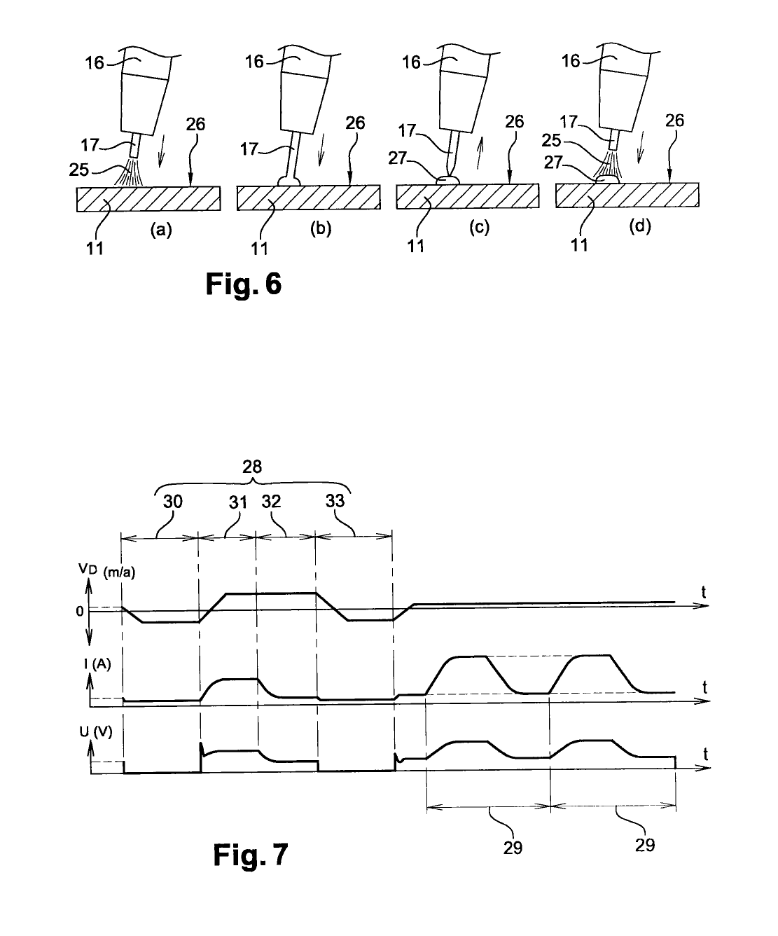

FIG. 6 shows the different steps implemented during the CMT welding method,

FIG. 7 is a set of diagrams illustrating the different steps of the CMT welding method.

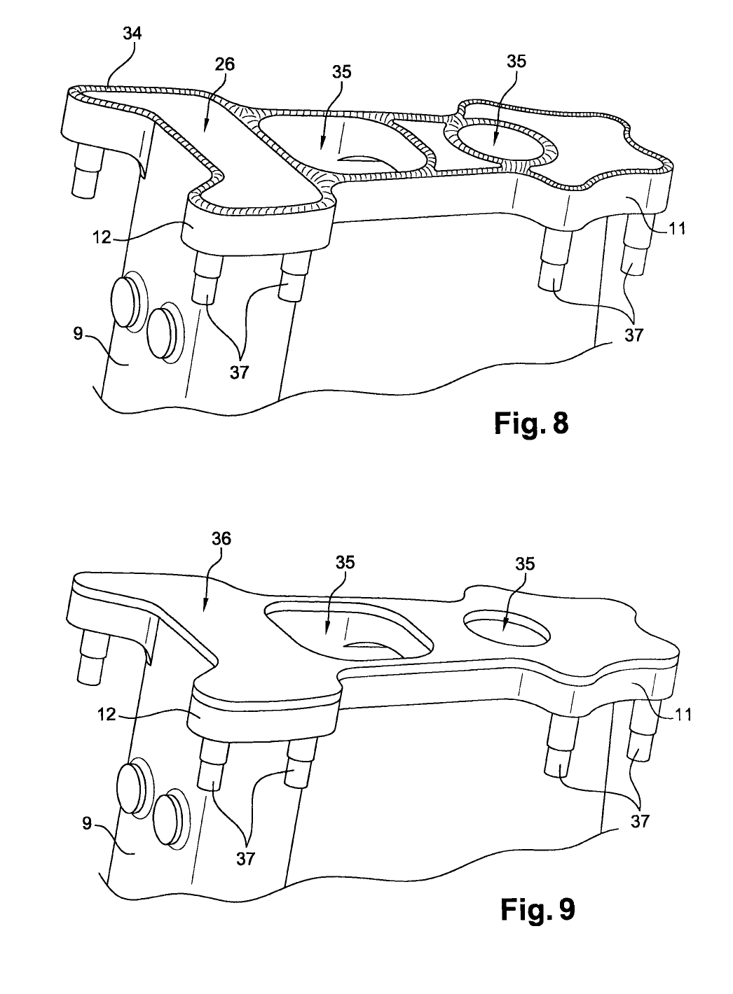

FIGS. 8 and 9 are two views corresponding to FIG. 2 illustrating an example of a resurfacing strategy according to the invention.

FIG. 1 shows a turbomachine of the prior art comprising, from upstream to downstream, a fan 1, a separator 2, a low-pressure compressor 3, an intermediate casing 4, a high-pressure compressor 5, a combustion chamber, a high-pressure turbine and a low-pressure turbine (not shown). The air flow F entering the turbine engine is divided into a main flow F1 which flows inside the low- and high-pressure compressors 3, 5, and a by-pass flow F2 which bypasses the compressor 3, 5, the combustion chamber and the turbines.

The intermediate casing 4 comprises an outer shroud 6 and an inner hub 7 defining a portion of the jet 8 wherein the by-pass stream F2 flows. The shroud and the hub 7 are connected together by radial structural arms 9 which are circumferentially spaced from each other at regular intervals. Such arms 9 have a high mechanical strength making it possible, on the one hand, to transmit the forces from the shroud to the hub and, on the other hand, to withstand any projectiles that might impact these.

In addition, the arms 9 each have a shape so contoured as to perform a function of outlet guide vane or OGV aiming at straightening the by-pass air flow F2 in order to limit the turning thereof.

As indicated above, during the production of the intermediate casing 4, defects may be generated on the arm 9 during a machining (for example when the cutting tool used for machining is damaged).

The defects caused by machining usually appear at the radially outer ends 10 of the arms 9, especially at the shoes 11 forming these ends 10. As best shown in FIG. 2, such a shoe 11 has several lobes 12 at its peripheral edge.

In addition, upon welding the arms 9 on the hub 7 material shrinkage phenomena may cause dimensional nonconformities.

To remedy this problem, the invention provides a method for striking-off soles 11 of non-compliant arms 9 (defects in the shoe 11, not complying dimensions, . . . ), to resurface the shoe 11 by adding filler metal using a short circuit transfer MIG welding method, also called CMT (Cold Metal Transfer) method, and then machining the resurfaced portion of the arm 9 so as to provide it with the required geometry.

It should be noted that the step of striking-off is not necessarily required.

Resurfacing the struck-off shoe 11 makes it possible to recreate a sound shoe, free of defects, and/or to compensate the shrinkage phenomena by adding an extra thickness of material.

The principle of the CMT method is known in particular from the document U.S. Pat. No. 8,124,913 and the parameters of this method have, according to the invention, been adapted for efficiently resurfacing this type of shoe 11.

To perform the step of resurfacing the shoe 11, the arm 9 is mounted in a box 13 used to confine an inert gas, such as ARCAL 32 comprising 80% of argon and 20% of helium (FIGS. 4 and 5).

The casing 13 includes a side wall 13a enclosing the arm 9 closed by a removable plate 14 having a central opening 15 (FIG. 5) for the passage of a head 16 carrying a consumable electrode 17 (FIGS. 3 and 6) used as a filler metal. The electrode 17 is made, for example of TA6V.

The side wall 13a includes ball bearings 18 whereon the plate 14 is positioned. Such bearings 18 thus make it possible to facilitate the movement of the plate 14. The edges of the plate 14 have rims 19 turned downwards and intended for guiding the sliding of the movable plate 14 relative to the side wall 13a. The movable wall 14 is also equipped with a connection 20 for an inert gas supply pipe (FIG. 5).

The casing 13 and the arm 9 are fixedly mounted on a support plate 21 of a numerically controlled machine 22 comprising the head 16, the electrode 17 and means 23 for controlling the movement and the operation thereof. The numerically controlled machine 22 also comprises an interface 24 enabling an operator to adjust the CMT method parameters.

The principle of the CMT method will now be described while referring to FIGS. 6 and 7.

In this method, the consumable electrode 17 (which may, for instance be a wire) is cyclically movable relative to the head 16. During a cycle, an electric arc 25 is first generated between the electrode 17 and the surface 26 of the part to resurfaced 11 (phase (a)), using a pulsed current source, so as to cause the local melting of a zone of the work piece 11. During this phase, the electrode 17 is directed towards the surface 26 of the piece 11 until the end of the electrode 17 is immersed in the melt bath. The electric arc 25 is then extinguished and the welding current is reduced (step (b)). The electrode 17 is then moved away from the part 11, with the backward movement of the electrode 17 during the short circuit phase facilitating the coming off of a drop 27 of filler metal. During this phase referenced (c) in FIG. 6, the short-circuit current is kept at a low value. Then, during a phase referenced (d) in FIG. 6, the movement of the electrode 17 is reversed, so as to start a new cycle. Meanwhile, the electrode 17 is moved relative to the surface 26 of the part to be resurfaced 11, so that the successive drops 27 of filler metal form a bead of filler material after cooling.

Such a method works using a synergistic law which controls the supply of energy. Such a law is represented in a diagram in FIG. 7.

No law of the prior art is perfectly suited to titanium alloys, more particularly alloys of the TA6V type, and to the geometry of the shoe to be resurfaced. A law has thus been developed therefor within the scope of the invention, and is schematically shown in FIG. 7. This figure includes several diagrams showing the evolution of the moving speed Vd of the electrode (also called wire feed speed), the intensity I flowing through the electrode and the difference of potential U applied between the electrode and the work piece to be resurfaced vs. time t.

This law comprises a starting cycle 28, followed by several pulse cycles 29.

The starting cycle 28 includes the following successive phases:
a first phase 30 of removing the electrode 17 and of generating a short-circuit: the electrode 17 is moved away from the surface to be resurfaced 26 at a maximum speed Vd of −1 to −3 m/min, with a negative value indicating a distance from the electrode 17 and the surface 26 to be resurfaced as opposed to a positive value which indicates a closer position of the electrode 17 and said surface 26. The intensity I is maintained at a reduced threshold of 50 to 70 A and the voltage U is substantially zero since the electrode 17 touches the surface 26 of the piece 11 (short circuit). This phase 30 lasts from 0.5 to 4 ms.
a phase 31 of pulse and of generating an arc: the movement of removing the electrode ends 17 and the electrode 17 is positioned closer to the surface 26 to be resurfaced, until the speed Vd reaches a maximum threshold of 24 to 26 m/min. Meanwhile, the intensity I increases up to a threshold of 130 to 140 A, with the effect of generating an electric arc 25. Such phase lasts from 1 to 3 ms.
a so-called combustion phase 32: the speed Vd is maintained at the threshold of 24 to 26 m/min, with the intensity I being reduced to a threshold of 90 to 110 A, sufficient to maintain the existence of an arc 25. Upon completion of this phase, the electrode 17 touches the surface 26 of the part 11 to be resurfaced again so as to generate a short circuit and to extinguish the electric arc 25 (if the electric arc was maintained during the phase of combustion). This phase lasts from 0.5 to 4 ms.
a second phase 33 of removing the electrode and of generating a short-circuit: the electrode 17 moves away from the surface 26 to be resurfaced at a maximum speed Vd of −1 to −3 m/s, the intensity I is maintained at a reduced threshold of 50 to 70 A and the voltage U is substantially zero since the electrode 17 touches the surface 26 of the piece 11 (short circuit).

During the starting cycle, the electrode 17 is moved relative to the surface to be resurfaced 26 at a constant speed ranging from 20 cm/min to 50 cm/min.

The starting cycle 28 detailed above, is followed by several pulse cycles 29 during which the speed Vd is brought to a stable value ranging from 2 to 7 m/min (the electrode 17 is gradually consumed) and the intensity I cyclically varies between a minimum value ranging from 70 to 100 A and a maximum value ranging from 280 to 320 A. The duration of a cycle 29 ranges from 2 to 2.5 ms (i.e. a pulse frequency between 400 and 500 Hz) and the number of pulse cycles 29 ranges for example from 80 to 120. During this period, the feed speed of the head 16 (and therefore of the electrode 17 too) relative to the surface 26 of the part 11 is preferably maintained substantially constant and ranges from 10 to 120 cm/min.

Upon completion of the resurfacing, a local thermal treatment of the work piece can be carried out.

FIGS. 8 and 9 illustrate a resurfacing strategy according to one embodiment of the invention. The strategy consists in providing a bead of material 34 along the edges of the surface to be resurfaced 26 of the shoe 11 and, optionally, along the edges of the openings 35 of the shoe 11 (FIG. 8), and then to deposit material 36 on the rest of the struck-off surface 26, by providing successive and adjacent beads (FIG. 9). The beads of material thus obtained may be from 5 to 10 mm wide, and from 3 to 5 mm thick.

Although a single layer of material 36 is generally sufficient for the intended applications, several layers of materials may be successively deposited, depending on the thickness of material required to obtain the desired resurfacing.

Thanks to the method according to the invention, resurfacing time of a shoe 11 is of the order of 3 hours i.e. much less than the resurfacing time required in the prior art (about 20 hours).

The trajectories of the head 16 are adapted so as to obtain a slight overlapping of the beads, in order to avoid a lack of material and/or the occurrence of holes between the beads.

During these different phases, the parameters used make it possible to prevent or to limit the projections of material to minimize the heat affected zones (HAZ), to avoid the burning or shrinking phenomena at the beginning and at the end of the bead, and to avoid geometric deformation of the shoe 11 (minimization of thermal stresses within the material). In particular, intermissions between each pass and/or the different layers of material 36, between 60 and 600 seconds, allow sufficient cooling of the beads and/or the layers of filler metal to prevent the appearance of geometric deformations of the shoe 11.

In order to best control the quality of the resurfacing executed, temperature sensors 37 in the form of thermocouples are fixed locally in the most critical zones (i.e. in the hottest zones), which are the lobes 12 of the shoe 11.

The thermocouples 37 are mounted under the shoe 11 at these lobes 12, as can be seen in FIGS. 4, 5, 8 and 9.

As mentioned above, such thermocouples 37 return information about the temperatures of the concerned zones of the shoe 11, with such information being then used to adapt the various parameters of the CMT method accordingly.

A rising temperature detected in a zone 12 will require for example a reduction in the intensity of the current flowing through the electrode 17, a longer intermission between two passes, etc. . . . .

1. A method for resurfacing at least one arm of an intermediate casing of a turbomachine said method comprising the steps of:
striking off at least one end of the arm to be resurfaced,
resurfacing the struck-off end of the arm by adding filler metal using a short-circuit transfer MIG welding, also called CMT (Cold Metal Transfer) method, wherein a consumable electrode is used as a filler metal,
machining the resurfaced portion of the arm so as to provide said resurfaced portion with the required geometry,
wherein, upon resurfacing using the CMT method, a synergistic law is used, which comprises an ignition cycle during which the intensity I of a current flowing through the electrode varies from a minimum value of 50 to 70 A to a maximum value of 130 to 140 A, followed by several pulse cycles during which the intensity I varies from a minimum value of 70 to 100 A to a maximum value of 280 to 320 A.

2. The method for resurfacing according to claim 1, wherein the arm is made of a titanium alloy,
and wherein the starting cycle comprises the following successive phases:
a first phase of removing an electrode and of generating a short circuit, during which the electrode is moved away from the struck-off end to be resurfaced at a maximum speed Vd of −1 to −3 m/min, with the negative value indicating a distance from the electrode and the struck-off end to be resurfaced, with the intensity I being maintained at a reduced threshold, of 50 to 70 A and the voltage U being substantially zero,
a phase of pulse and of generating an arc during which the movement of removing the electrode ends and then the electrode is placed closer to the struck-off end to be resurfaced until the speed Vd reaches a maximum threshold of 24 to 26 m/min, and during which the intensity I increases up to a threshold of 130 to 140 A, with the effect of generating an electric arc,
a so-called combustion phase during which the speed Vd is maintained at the threshold of 24 to 26 m/min, with the intensity I being reduced to a threshold of 90 to 110 A, sufficient to maintain the existence of an electric arc, and during which, upon completion of such phase, the electrode touches the struck-off end to be resurfaced again so as to generate a short circuit and to extinguish the arc, if the arc was maintained during the combustion phase,
a second phase of removing the electrode and of generating a short-circuit during which the electrode is moved away from the struck-off end to be resurfaced at a maximum speed Vd of −1 to −3 m/s, with the intensity I being maintained at a reduced threshold, of 50 to 70 A and the voltage U being substantially zero,
wherein, during the pulse cycles, the speed Vd is adjusted to a stable value of 2 to 7 m/min so that the electrode is gradually consumed and the intensity I cyclically varies between a minimum value of 70 to 100 A and a maximum value of 280 to 320 A.

3. The method for resurfacing according to claim 2, wherein:
the duration of the first phase of removing ranges from 0.5 to 4 ms, and/or
the duration of the pulse phase and of generating an arc ranges from 1 to 3 ms, and/or
the duration of the combustion phase ranges from 0.5 to 4 ms, and/or
the duration of a pulse cycle ranges from 2 to 2.5 ms.

4. The method according to claim 1, wherein, during the starting cycle, the electrode is moved relative to the struck-off end to be resurfaced at a constant speed, between 20 cm/min and 50 cm/min.

5. The method according to claim 1, wherein the number of pulse cycles ranges from 80 to 120.

6. The method according to claim 1, wherein during the pulse cycle, the feed speed of the electrode relative to the struck-off end to be resurfaced is maintained substantially constant and ranges from 10 to 120 cm/min.

7. The method according to claim 1, wherein, upon completion of the resurfacing of the struck-off end of the arm a local thermal treatment of said arm is carried out.

8. The method for resurfacing according to claim 1, wherein, during the step of resurfacing the struck-off end of the arm, the CMT method parameters are controlled so as to limit the heating of the resurfaced zone.

9. The method according to claim 8, wherein the end of the arm is equipped with at least one temperature sensor such as a thermocouple.

10. The method according to claim 1, wherein, during the resurfacing step, a bead of material is first provided at least along the edges of the struck-off surface of the end of the arm and material is then applied on the remainder of the struck-off surface.

11. The method according to claim 1, wherein, during the resurfacing step, the arm is mounted in an enclosure containing an inert gas.

12. The method according to claim 11, wherein the enclosure comprises a removable plate comprising an opening for the passage of a welding tool positioned opposite the end of the arm to be resurfaced.

13. The method according to claim 1, wherein the titanium alloy used for the arm is TA6V, with the filler metal used in the CMT welding being TA6V.

14. The method according to claim 1, wherein it is automatically executed on a numerically controlled machine.
